(19) United States
(12) Patent Application Publication
(10) Pub. No.: US 2026/0050257 A1
(43) Pub. Date: Feb. 19, 2026

(54) SYSTEM AND METHOD TO IDENTIFY INTERCHANGEABLE ELECTRICAL COMPONENTS

(71) Applicant: Joseph Michael Sieger, Carrollton, TX (US)

(72) Inventor: Joseph Michael Sieger, Carrollton, TX (US)

(73) Assignee: JOSEPH MICHAEL SIEGER Trust, Barrington, IL (US)

(21) Appl. No.: 19/299,791

(22) Filed: Aug. 14, 2025

Related U.S. Application Data
(60) Provisional application No. 63/683,370, filed on Aug. 15, 2024.
(60) Provisional application No. 63/685,860, filed on Aug. 22, 2024.

(51) Int. Cl. G05B 23/02

(52) U.S. Cl. CPC G05B 23/0278; G05B 23/0272; G05B 2219/24069; G05B 2219/2637

(57) ABSTRACT

Briefly, one or more embodiments are direct to a process, system, and article for determining interchangeability of one or more electrical components of a particular motor vehicle. Performance of a diagnostic scan may be initiated of the particular motor vehicle. Results of the diagnostic scan may be received. One or more service part numbers/identifiers for electrical components interrogated during the diagnostic scan may be identified. One or more electronic parts catalogs indicating vehicle manufacturer part numbers/identifiers for electrical components of a set of motor vehicles may be accessed. One or more cross-references between the service part numbers/identifiers for electrical components interrogated during the diagnostic scan and the vehicle manufacturer part numbers/identifiers may be determined. The cross-references may be stored in one or more records of a database.

### CROSS-REFERENCE TO RELATED APPLICATIONS

The present application claims the benefit of U.S. Provisional Patent Application No. 63/683,370, entitled “METHOD TO IDENTIFY ELECTRICAL COMPONENTS THAT ARE INTERCHANGEABLE” and filed on Aug. 15, 2024; and U.S. Provisional Patent Application No. 63/685,860, entitled “METHOD TO DETERMINE A CATEGORY OF STOCK KEEPING UNIT” and filed on Aug. 22, 2024; the entire content of each of the aforementioned provisional applications are incorporated herein by reference in their entirety.

### BACKGROUND

A vehicle, such as an automobile, may include hundreds, if not thousands of different parts or components. If a part breaks or is otherwise faulty, the part may be removed and replaced with a new or a used part which is still in working condition. For example, new versions of certain parts, such as windshield wipers, may be readily available for purchase and use in an automobile for which the existing windshield wipers are broken or otherwise faulty. However, some other components, such as electronic modules within an automobile may be highly specialized such that a new electronic module may not be readily available for purchase. For example, if the electronic module is highly specialized, the electronic module might have be made if an order is placed for the electronic module, a process which may potentially take weeks, if not months to fulfill, partially if a manufacturer of the electronic module is located overseas or there is some other type of supply chain delay. Accordingly, instead of using a brand-new electronic module in the place of a non-working or otherwise faulty electronic module, a suitable electronic module or other component may be removed from an existing vehicle and installed into the vehicle in the place of the faulty electronic module. For example, there is an entire industry of used vehicle parts in which older or partially damaged vehicles are dismantled, and usable parts are harvested from the vehicles and sold to third parties.

However, it may not be readily apparent if a particular component acquired from a dismantled vehicle is usable within a different vehicle which requires a replacement component. For example, certain automobile manufacturers change their part numbers for certain automobile parts over time. Moreover, different manufacturers may also employ different part numbering schemes such that even if the same component is used in vehicles manufactured by different companies, such as General Motors™ and Mercedes™, each manufacturer may employ a different part number for the same component, such as a window motor in a door, for example.

Moreover, it is often unclear as to which category of product a particular component belongs. For example, if a particular module is disposed within a case or box and installed within the engine block of a vehicle, it may not be readily apparent what the module is or to what category it belongs, such as if the module does not include a part name printed on the case or box. If the module does not include a part name printed thereon, it may be difficult for a technician to quickly determine what category or type of module is included in the case or box, potentially making replacement of the module more difficult or time-consuming.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 illustrates an embodiment of some entities involved in vehicle repair and salvage.

FIG. 2 illustrates an OBD2 (On-Board Diagnostics II) scanner according to an embodiment.

FIG. 3 illustrates an embodiment of a sonar controller of a vehicle.

FIG. 4 illustrates an embodiment of a system for performing a diagnostic scan of a vehicle and determining the interchangeability of one or more electrical components or modules of vehicle.

FIGS. 5A and 5B collectively illustrate an embodiment of a first portion and a second portion of a diagnostic scan report of a vehicle.

FIG. 6 illustrates an embodiment of an example of a record which may be stored in a database for a particular vehicle component.

FIG. 7 illustrates an embodiment of a flow diagram for determining interchangeability of one or more components of a vehicle.

FIG. 8 illustrates an embodiment of two control modules of a vehicle which have the same end model part number, but different base model part numbers.

FIG. 9 illustrates an embodiment of various items of information associated with a module, such as a Serial Data Gateway Module.

FIG. 10 illustrates an embodiment indicating interchangeability of control modules of three different vehicles.

FIG. 11 illustrates an embodiment of a portion of a list part names and associated part numbers for various vehicle components.

FIG. 12 illustrates an embodiment of an electrical component of a vehicle for which a category of the part or component is unknown.

FIG. 13 illustrates an embodiment in which part categories for two electrical components may be determined.

FIG. 14 illustrates an embodiment in which part categories for two electrical components may be determined.

FIG. 15 illustrates an embodiment of an association between an Engine Control Unit (ECU) and a key-value pair.

FIG. 16 illustrates an embodiment of diagnostic scan reports for two different vehicles.

FIG. 17 illustrates an embodiment of a chart of attributes of a vehicle component and associated part category numbers.

FIG. 18 illustrates an embodiment of a chart of attributes of a vehicle component and associated part category numbers.

FIG. 19 illustrates an embodiment of a flow diagram for determining a likely part category for one or more components of a vehicle.

FIG. 20 illustrates an embodiment of a system for determining a likely part category for one or more electrical components or modules of a vehicle.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

One or more embodiments, as discussed herein, are directed to a system and process for determining the interchangeability of one or more electrical components of an automobile or other vehicle. The terms ““vehicle,” “motor vehicle,” and “automobile” are used interchangeably herein. There are several ways in which to determine whether a part is interchangeable, such that a component or part may be removed from one vehicle and reused in a different vehicle. An “interchangeable” automobile component or part, as used herein, refers to is a part or component that is identical or functionally equivalent to another part, meaning it can be easily and readily swapped out and replaced in a vehicle without custom fitting or modifications such as requiring parts, equipment, tools, and skill not readily on-hand at typical repair workshop. Such interchangeability may allow for easier, simpler, and faster assembly, repair, and wider availability of replacement parts across different vehicle models or manufacturers, leading to potential cost and time savings. For example, if a particular vehicle component which is still in working condition is removed from a 2022 Buick™ vehicle, the component may likely be installed in a different 2022 Buick™ vehicle. However, the same vehicle component may also be usable within other makes and models of vehicles, such as a Tesla™ or Mercedes™ vehicle in some instances. A barrier to simply installing the component removed from the 2022 Buick™ vehicle may relate to a numbering scheme employed. For example, a part from a 2022 Buick™ may have a part number printed on it which is unique to Buick vehicles and it may not be readily apparent that the part number for the Buick™ part numbering system may be equivalent to a vehicle component from a Telsa™ vehicle which employs a different part numbering system, unique to Tesla™. Accordingly, determining which different part numbers refer to the same component within different part numbering systems would be useful for determining interchangeability of a vehicle component within a variety of different makes and models of vehicles.

One way of determining interchangeability of a vehicle component is to access an electronic parts catalog for a vehicle manufacturer. As used herein, an electronic parts catalog, or “EPC,” for a vehicle refers to a digital database containing comprehensive information about all parts of a specific vehicle, including their details, specifications, pricing, availability, and compatibility. An electrics parts catalog may help service technicians, auto engineers, and individuals find the correct replacement parts for repairs and maintenance. For example, an electronic parts catalog may be accessed for General Motors™, which includes the part categories, names, and part numbers for some, or all, of the various components for a particular make and model of a General Motors™ vehicle. In one aspect, an electronic parts catalog may be accessed for General Motors™ to determine the components of a 2025 Cadillac Laroque™. Similarly, such an electronics parts catalog may also include indexing for various parts so that someone accessing the electronic parts catalog may determine which vehicle makes and models may utilize a particular component. For example, one may access a General Motors™ electronic parts catalog and may determine that a particular HVAC control module may be used in 2024 and 2025 Cadillac Laroque™ models, as well as a 2023 Buick Regal™, for example. Accordingly, if such an HVAC control module is removed from a 2023 Buick Regal, the HVAC control module may be installed into a 2024 Cadillac Laroque™. There may be multiple other components which may be interchangeable between different makes and models of a particular vehicle, for example. An electronics parts catalog may also indicate information such as a part number for the HVAC control module, for example.

A second way to determine interchangeability is to visually inspect a particular component. For example, a module inside of a General Motors™ vehicle may include a General Motors™ part number printed on it. The same module may also, in some instances, include a second number printed on it if the module is manufactured by a Tier 1 supplier, for example. In an embodiment, the General Motors™ part number and the Tier 1 Supplier part number for a module may be different part numbers and may have different numbering schemes. A vehicle manufacturer, such as General Motors™, Ford™, or Mercedes™, to name just a few examples among many, is considered to be an Original Equipment Manufacturer (OEM) within the automotive industry, meaning that they design and build vehicles and produce the parts used in their manufacturing process. In a supply chain, a “Tier 1 supplier,” as used herein, refers to an entity, such as a company, which directly supplies products or components to an OEM. A “Tier 2 supplier,” as used herein, refers to an entity, such as a company, which supplies materials or sub-components to Tier 1 suppliers.

A third way of determining interchangeability is by visually inspecting a part and determining whether certain physical aspects of a potential replacement part match those of an existing part which is to be removed from a vehicle. For example, a water pump within a vehicle may have bolt holes in specific locations of the body of the water pump for coupling the water pump to a chassis of the vehicle. If a potential replacement water pump has bolt holes disposed at the same respective locations as those of the original water pump being removed from the vehicle, the identification of the matching bolt holes may, in some cases, be an indication that the replacement water pump may be installed within the chassis of the vehicle. In some embodiments, an operator may look for multiple different indicators of interchangeability in order to infer that the replacement water pump, or some other component, may be interchangeable with an existing component of the vehicle.

Determining which vehicle components are interchangeable within different makes and models of different vehicles is of critical importance to an automobile dismantler or to an entity which licenses a database of information including which vehicle components are interchangeable within a variety of different vehicle makes and models.

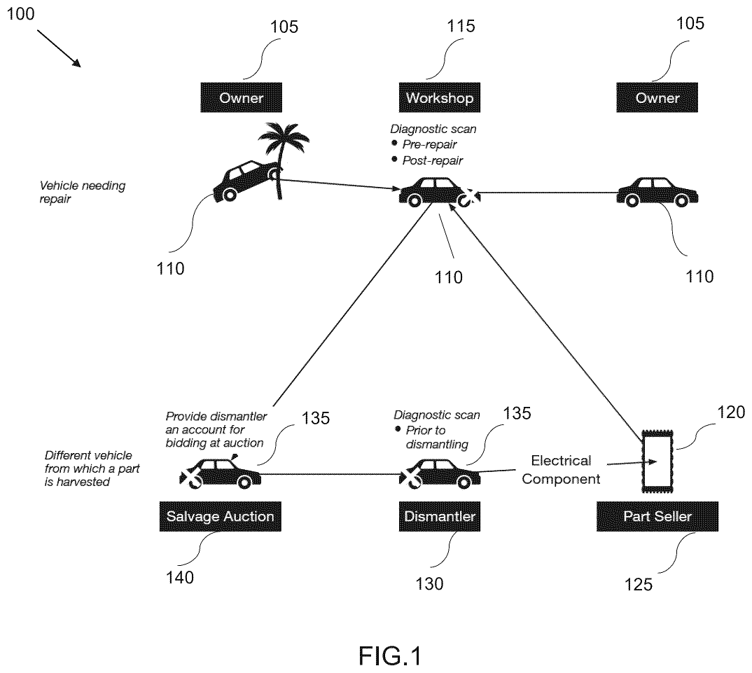

FIG. 1 illustrates an embodiment 100 of some entities involved in vehicle repair and salvage. As shown, an owner 105 of a first vehicle 110 may be involved in an accident or may have some other type of loss event after which the first vehicle 110 is in need of repair. A workshop 115 may be given custody of the first vehicle to determine whether the first vehicle 110 is capable of being repaired. For example, the owner 105 may either drive the first vehicle 110 to a workshop 115 or the first vehicle 110 may be towed to the workshop or end up at the workshop 115 some other way. A technician at the workshop 115 may perform a pre-repair diagnostic scan of the first vehicle 110 to determine what components and/or systems of the first vehicle are damaged or otherwise in need of repair or replacement. A “diagnostic scan,” as used herein, refers to a process for retrieving diagnostic trouble codes and other data from a vehicle's onboard computer. A “diagnostic trouble code” or “DTC,” as used herein, refers to a code generated by a vehicle's OBD system to indicate a specific problem, helping pinpoint the location and nature of a malfunction. Diagnostic trouble codes are designed to alert vehicle owners and mechanics to potential issues with the vehicle's systems.

A diagnostic scan on a vehicle may be performed by connecting a specialized tool, called an OBD2 (On-Board Diagnostics II) scanner, to the vehicle's Diagnostic Link Connector (DLC) which allows access to the car's computer or OBD system. A DLC comprises a multi-pin diagnostic connection port for automobiles, trucks, and motorcycles used to interface an OBD2 scanner with the control modules of a given vehicle and access on-board diagnostics and live data streams. A DLC is often located under the instrument panel on the driver's side. The instrument panel is a portion of the dashboard which sits behind the steering wheel of first vehicle 110. The instrument panel comprises a control panel that displays information about the first vehicle's 110 status and performance.

OBD is a system that monitors the first vehicle's 110 computer system and reports diagnostic trouble codes. When a vehicle's OBD system detects a malfunction, it may generate an appropriate diagnostic trouble code and may send an alert to the owner of the vehicle via a light or other indicator on an instrument panel of the vehicle.

If an automobile is brought to a workshop for potential repairs, a workman may connect an OBD2 scanner to the vehicle's DLC to prompt the vehicle's OBD system to perform various tests. For example, the OBD2 scanner may prompt the OBD system to ping or contact every control system in the first vehicle 110 to determine whether any of the control systems or electrical components exist or are malfunctioning. In the event that one or more of the control systems or electrical components is not functioning properly, a trouble code for a faulty control system or faulty electronic component may be transmitted to the OBD2 scanner so that the trouble code may be displayed to a workman.

In some embodiments, one or more of workshop 115, dismantler 135, or part seller 120 may may access to, or may otherwise be in communication with a device or entity which determines or indicates the interchangeability of a vehicle component or module. Such a device may comprise a database or server which indicates the interchangeability of a vehicle component or module between different vehicles and/or the interchangeability of a component of a particular manufacturer and having a particular part number being interchangeable with another component manufactured or otherwise provided by a different manufacturer and having a different part number, such as is discussed in more detail below.

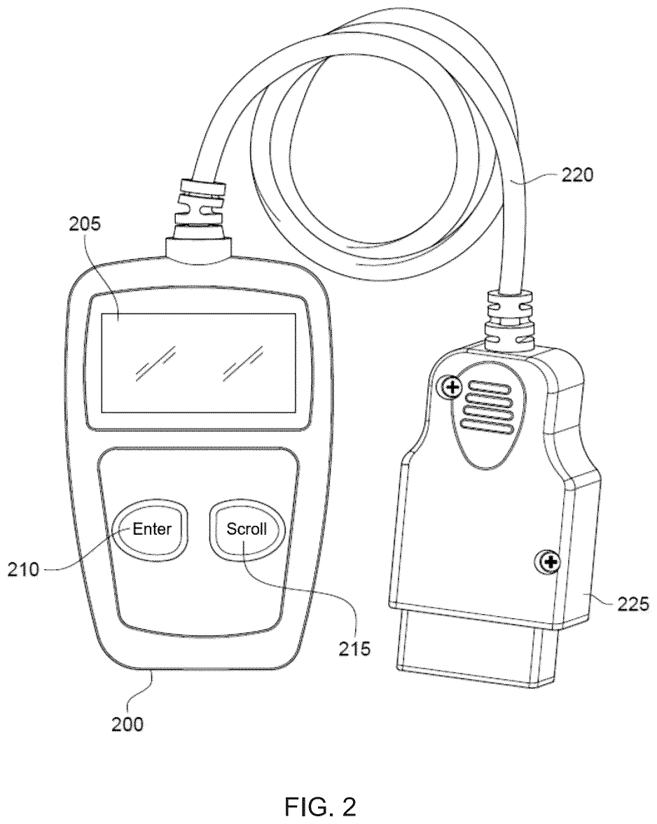

FIG. 2 illustrates an OBD2 scanner 200 according to an embodiment. As shown, OBD2 scanner 200 may comprise a handheld mobile device which includes a display 205, one or more input buttons or keys, such as enter button 210 and a scroll button 215, to name two examples of buttons or keys on an OBD2 scanner. In some embodiments, OBD2 scanner 200 may include a keypad or may be capable of being coupled to a keypad, keyboard, and/or some other user input device to receive user inputs. OBD2 scanner 200 may include or be coupled to a plug 225 via a cord 220. Plug 225 may be detachable connected to a vehicle's DLC to initiate a diagnostic scan and/or to receive the results of such a diagnostic scan of the vehicle. For example, if there are any detected faulty components of a control system or electrical components of the vehicle, one or more diagnostic trouble codes may be presented to a technician via display 205. In some embodiments, an explanation for each detected trouble code may also be presented on display 205. In some embodiments, a diagnostic scan may be performed on a vehicle even if the vehicle is not believed to have faulty components. For example, a diagnostic scan may be performed on a vehicle so that various systems are interrogated and return identification numbers, such as part numbers. Accordingly, instead of having to manually inspect vehicle and potentially disassemble certain components in order to locate part numbers for components, in some implementations, a diagnostic scan may be performed on the vehicle and identifying information for interrogated systems and components may be received and/or determined during the diagnostic scan. For example, an interrogated system may respond to control signal or status request during performance of the diagnostic scan by providing identifying information, such as part numbers, for components of the system. Such identifying information may subsequently be utilized to determine which hardware and software components and modules are utilized by the vehicle. Some vehicles may also, or alternatively, have the functionality to export data wirelessly or through a port other than an OBD2 port. Accordingly, it should be appreciated that a diagnostic scan refers to a process for retrieving diagnostic trouble codes and other data from a vehicle's onboard computer.

An ODB scanner 200 may obtain an identifier of the first vehicle 110 when connected to the vehicle's DLC. The OBD2 scanner 200 may also determine all of the modules of the first vehicle 110. A “module,” as used herein, refers to a component, such as an electrical component, computing device, or computer that controls a specific function or set of functions in a vehicle. A module is not limited to a component that includes hardware in addition to that of a control unit or acts as a subsystem under a control unit. A module may comprise a part of a vehicle's electronic control systems, often communicating via the vehicle's Controller Arca Network (CAN) bus or other protocols.

New cars often have more than 30 different modules within them. Examples of commonly used modules include an engine control module which manages the vehicle's engine's performance by monitoring sensors and adjusting fuel injection, ignition timing, and other functions. A transmission control module may manage shifting, particularly in automatic transmissions. A powertrain control module may combine the functions of the engine control module and transmission control module into one unit. A brake control module may control a vehicle's wheels and braking system. A door control unit module may control the doors of the vehicle. An electric power steering control unit module may control an electric power steering system of the vehicle. A human-machine interface module may enable a human operator to interact with a machine or system of the vehicle. A seat control unit module may control the seats of the vehicle. A speed control unit module may control the speed of the vehicle. A telematic control unit module may manage telematics services, essentially acting as a communication hub to collect, process, and transmit data about the vehicle's location, performance, and driver behavior to external systems, enabling features like vehicle tracking, emergency call systems, and driving analysis. A battery management system module may monitor the state and health of one or more batteries of the vehicle.

Referring back to FIG. 1, after performing a pre-repair diagnostic scan, the results of the scan may be presented to a technician at workshop 115. For example, an ODB scanner 200 may read data from various sensors and components to identify any malfunctions or error codes, essentially providing a detailed analysis of the car's health and pinpointing potential problems by interpreting the stored codes displayed on a display of ODB scanner. Results of the diagnostic scan may include learning the identification number of an electrical component 120 in a circuit or system or a diagnostic trouble code from a damaged or faulty circuit or system. After performing the pre-repair diagnostic scan, the workshop 115 may provide results of the diagnostic scan to owner 105 and may inform the owner 105 whether the first vehicle 110 should be repaired, or whether the extent of damage to first vehicle 110 is so great that repair would be prohibitively expensive. In the event that a decision is made to repair the first vehicle 110, the workshop 115 may contact a part seller 125 to obtain or otherwise order the replacement electrical component for use in the first vehicle 110. Part seller 125 may maintain an inventory of vehicle parts which have been harvested from or otherwise acquired by a dismantler 130. A dismantler 130 may comprise a component or other entity which purchases vehicles, such as a second vehicle 135 from a salvage auction 140. Many vehicles use specialized electronic components which may not be readily available in brand new condition. For example, there may be a controller which is only used within BMW™ vehicles of a particular model sold in a particular year and which may not currently be manufactured. In some instances, the controller may still be manufactured, but as a result of supply chain disruptions, a new replacement controller may not be available for an extended period of time, potentially months. Moreover, if the controller is only manufactured overseas, there may also be delays introduced while shipments of replacement controllers wait to go through Customs inspections at a port of entry, for example. Accordingly, instead of waiting for a potentially extended period of time for a newly manufactured replacement controller to be received for replacement of a damaged component, a replacement controller which has been in use and still has a serviceable lifespan may instead be acquired from an existing vehicle. For example, if a vehicle has incurred extensive damage to a body or engine but diagnostic tests reveal that at least some of the electrical or electronic components of the vehicle are still functioning properly, such electronic components may be harvested from the damaged vehicle and used as replacement electronic components for a different vehicle which is being repaired. In the embodiment shown in FIG. 1, dismantler 130 may run a diagnostic scan on second vehicle 135 after purchasing or otherwise acquiring the second vehicle 135 from the salvage auction 140. The diagnostic test may be performed to learn the identification number of an electrical component in a circuit or system or to learn whether the circuit or system has no diagnostic trouble code indicating the electrical component might be in working condition. Dismantler 130 may maintain an inventory of working components harvested from second vehicle 135 as well as from other vehicles purchased from salvage auction 140 or otherwise acquired some other way. Dismantler 130 may sell electrical component 120 to part seller 125 and part seller 125 may, in turn, sell electrical component 120 to workshop 115 to replace a damaged electrical component of first vehicle 110. After workshop 115 repairs first vehicle 110 by replacing the damaged electrical component with the electrical component 120 acquired from part seller 125, the workshop 115 may perform a post-repair diagnostic scan to confirm the repair before custody of the vehicle is given to the owner 105. In some embodiments, a single entity may comprise both the dismantler 110 and the part seller 125.

The results of the diagnostic scan of first vehicle 110 may be performed to determine diagnostic trouble codes for malfunctioning electrical components or modules to determine whether those electrical components or modules should be replaced. The diagnostic scan may indicate identifiers for each of the pinged electrical modules or components as well as DTCs determined for any of the pinged electrical modules or components.

Although the results of a diagnostic scan are typically used to determine which components are in working condition and/or which components are not working and in need of repair, certain information indicated within the diagnostic scan may be employed to determine the interchangeability of one or more components interrogated during the diagnostic scan. For example, information indicating vehicle part numbers for interrogated electronic components may be listed on a diagnostic scan. Accordingly, instead of having to have a human operator manually inspect a vehicle to determine identifiers for various components, some of which may not be easily accessible, identifying information for such components may instead, or additionally, be obtained from diagnostic scan results for the vehicle.

An automotive part provided from a vehicle manufacturer to a repair workshop is not always provided by itself. For example: sometimes it is provided along with one or more other parts (e.g., fasteners); sometimes it us provided physically assembled with one or more parts (e.g., mounted to a bracket, within a case, etc.); sometimes the part is hardware and it is provided with software.

The identification number for the part itself may differ from the identification number of the bundle of multiple parts that includes the part. The identification number for the part itself may differ from the identification number of the physically assembled parts that include the part itself. The identification number for the hardware part itself may differ from the identification number of the software part.

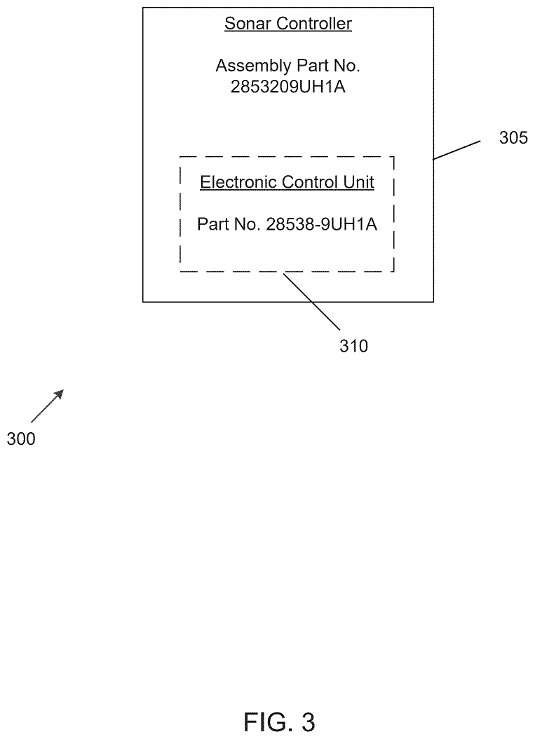

FIG. 3 illustrates an embodiment 300 of a sonar controller 305 of a vehicle. In embodiment 300, sonar controller 305 comprises an assembly comprising a case or shell, and with an electronic control unit 310 disposed within the case. The an identification number for the assembly, which is written on the case, such as “28532-9UH1A.” There may also be an identification number for the electronic control unit 310 also written on the case, such as “28538-9UH1A.” In this example, the identification number for the sonar controller assembly is different from the identification number for the electronic control unit 310 of the sonar controller 305. If a diagnostic scan is performed on a vehicle which includes the sonar controller 305, the electronic control unit 310 of the sonar controller 305 may communicate its identification number as one of these two numbers. The number communicated (e.g., 28538-9UH1A) sometimes is not the number a vehicle manufacturer uses to provide the part (e.g., 28532-9UH1A), thereby making it difficult to obtain the correct part.

Obtaining the correct part may be easier in the case where a repair workshop seeks to replace the non-working electronic control unit in a vehicle it is repairing with a used but working electronic control unit removed from another vehicle by an automotive recycler, when the identification number communicated by each electronic control unit is a factor used in determining whether one electrical component is interchangeable with the other.

When the part itself is an electrical component in a circuit or system of the vehicle, it may communicate its identification number in the course of a diagnostic scan, thereby appearing in a report about the health of the circuit or system.

This identification number can be used to determine the interchangeability of two bundles of parts, two assemblies of parts, etc.

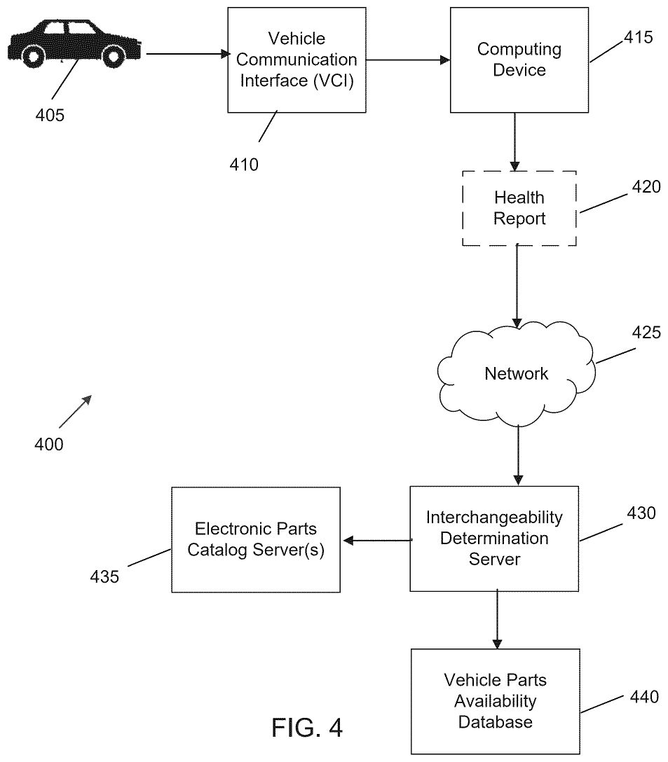

FIG. 4 illustrates an embodiment 400 of a system for performing a diagnostic scan of a vehicle 405 and determining the interchangeability of one or more electrical components or modules of vehicle 405. As illustrated, a diagnostic scan may be performed on vehicle 405. For example, a laptop computer 415 may include or have installed thereon a software application for initiating a diagnostic scan or diagnostic tests on vehicle 405, in a manner similar to OBD2 scanner 200 as shown in FIG. 2. Laptop computer 415 may have software installed thereon licensed from a manufacturer of vehicle 405. Laptop computer 415 may interface with a DLC of vehicle 405 via a Vehicle Communication Interface (VCI) 410. A VCI 410, as used herein, refers to a hardware component which allows a vehicle's electronic control units (ECUs) to communicate with external devices and diagnostic applications. An “ECU,” as used herein, refers to a typically small, computerized or electrical component that manages one or more systems within a vehicle by receiving data from sensors or other ECUs throughout the vehicle, processing the data, and then sending signals to actuators to adjust different functions, essentially acting as the “brain” of a modern automobile, controlling everything from engine performance and transmission to safety features like airbags and even comfort features such as power windows and climate control.

VCI 410 may plug into an OBD2 port of vehicle 405 on one end, and the other end may be coupled to laptop computer 415, such as through wired connection or through a wireless connection, such as BlueTooth™. Through use of VCI 410, an application running on laptop computer 415 may initiate a diagnostic scan of vehicle 405 and may generate a diagnostic scan report 420 about the health of the vehicle's 405 circuits and systems. The report 420 may be presented on laptop computer 415, such as within a web browser. In embodiment 400, when a technician utilizes laptop computer 415 to initiate a diagnostic scan of vehicle 405, a report 420 containing results of the diagnostic scan may be displayed within a web browser presented on a graphical user interface of laptop computer 415. For example, the report 420 of the results of the diagnostic scan may be stored locally on laptop computer 415.

In accordance with a particular embodiment, the application used to initiate the diagnostic scan may receive the results of the diagnostic scan from the VCI 410. In one implementation, the application may generate the report 420 which includes the results of the diagnostic scan, and that report 420 may be stored as a file in a storage location of the laptop computer 415, such as in a temporary storage area. The report 420 may be transmitted, such as by an application running on laptop computer 415, to interchangeability determination server 430 via a network 425, such as the Internet. Interchangeability determination server 430 may process the report 420, for example, to determine identifiers, such as component or part identifiers for modules interrogated during the diagnostic scan. Interchangeability determination server 430 may receive diagnostic reports over time from potentially thousands of vehicles over time and may store the identifiers for components identified on the diagnostic scan reports. Interchangeability determination server may additionally be in communication, directly or indirectly, with one or more electronic parts catalog server(s) 435. For example, General Motors™ may have its own electronic parts catalog server which indicates part numbers for components of various makes and models of General Motors™ vehicles. Similarly, other vehicle manufacturers, such as Ford™, Telsa™, or Mercedes™, to name just a few examples among many, may similarly have their own electronic parts catalogs which indicate part numbers for components of various makes and models of Ford™, Tesla™, or Mercedes™ vehicles, respectively. In some implementations, Tier 1 and/or Tier 2 suppliers may similarly have their own electronic parts catalogs which indicate part numbers or identifiers for components manufactured by, or otherwise used by such Tier 1 and/or Tier 2 suppliers. Some third parties may also utilize their own electronic parts catalogs which list identifiers for multiple vehicle manufacturers and/or Tier 1 or Tier 2 suppliers.

Interchangeability determination server 430 may utilize the identifier information contained within vehicle diagnostic scans in combination with information obtained from electronic parts catalog server(s) 435 to perform cross-references between vehicle parts. In other words, if electronic parts catalog server(s) indicates that a particular General Motors™ vehicle, such as a 2023 Skylark™ vehicle, utilizes a radio module having a particular General Motors™ part number, but a diagnostic scan of a 2023 Skylark indicates that a radio module installed therein has part number indicating a part number employed by a Tier 1 supplier of the radio module, interchangeability determination server 430 may identify a cross-reference between the General Motors™ part number indicated by the electronic parts catalog server(s) 435 with the Tier 1 supplier part number determined from a diagnostic scan. In some implementations, a radio module with the same part number may be utilized within a 2023 Tesla™ vehicle, although electronic parts catalog server(s) 435 may list a Tesla™-specific part number for the radio vehicle. Accordingly, a cross reference between the Tier 1 supplier part number may therefore be made with both the General Motors™ part number and the Telsa™ part number indicated within the electronic parts catalog server(s) 435. One reason why the same component would be associated with several different part numbers is because a vehicle manufacturer typically does not manufacture every component of a vehicle. Instead, a vehicle manufacturer, such as General Motors™, Ford™, or Telsa™, may obtain certain components, such as a radio module from a Tier 1 supplier who employs a part numbering scheme which may be unique to the Tier 1 supplier. However, when the Tier 1 supplier provides such a radio module to different vehicle manufacturers, each vehicle manufacturer may often employ their own part numbering scheme for the obtained module. Accordingly, the exact same module may potentially be associated with multiple different part numbers for different vehicle manufacturers. By determining such cross-references between components, such as a radio module, which is associated with multiple different part numbers, interchangeability of the module across multiple makes and models of vehicles may therefore be determined.

After determining the interchangeability of one or more electrical components or modules, interchangeability determination server 430 may store the determination of the interchangeability for the corresponding electrical component or module. In some implementations, interchangeability server 430 may transmit the results of various interchangeability determinations may to a vehicle parts availability database 440. For example, an inventory of various records for parts dismantled from vehicles may be stored in vehicle parts availability database 435 so that someone searching for a particular vehicle part can search the vehicle parts availability database to determine whether a suitable replacement part is available for purchase, such as from a vehicle parts supplier.

In some implementations, interchangeability determination server 430 may transmit the determination of the interchangeability of the one or more electrical components or modules back to computing computer 415 for display, for example.

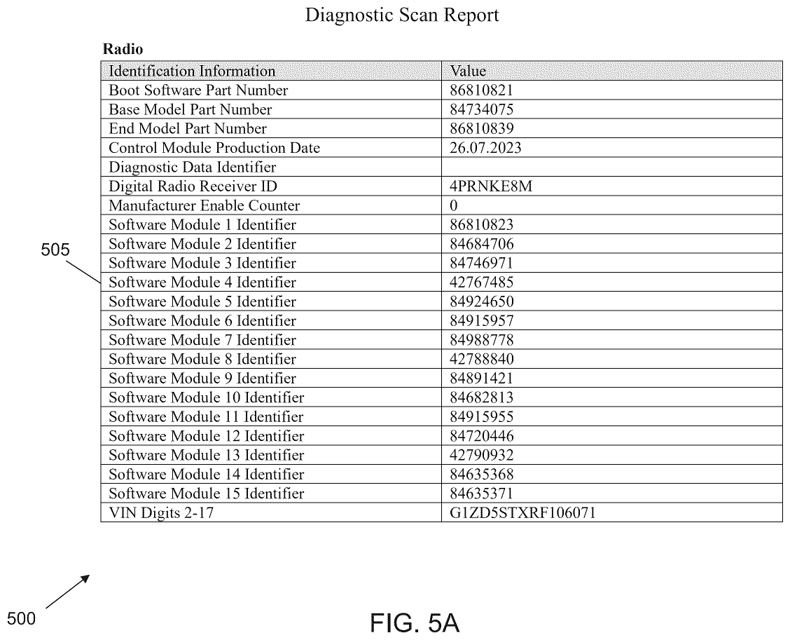

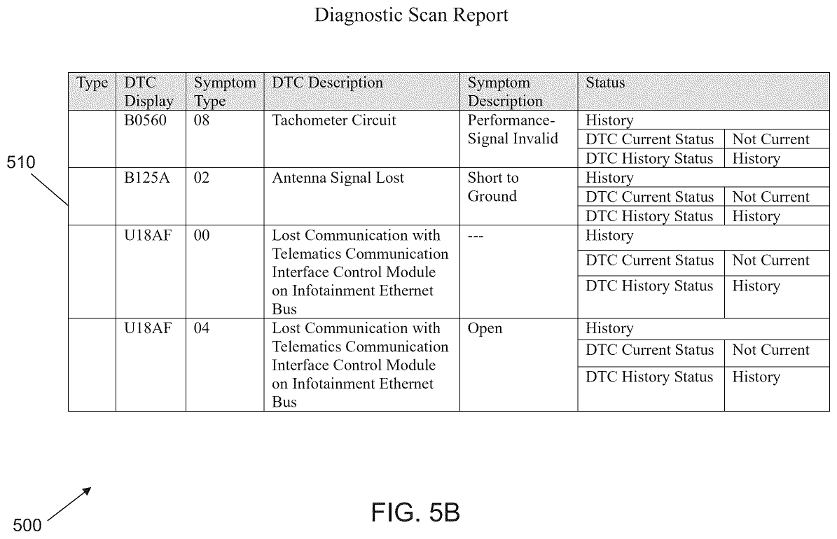

FIGS. 5A and 5B collectively illustrate an embodiment 500 of a first portion 505 and a second portion 510 of a diagnostic scan report of a vehicle. Embodiment 500 illustrates various information of a diagnostic scan report which relates to a radio control unit of a vehicle. Although a diagnostic scan report is typically generated to determine which components of a vehicle are working properly, or identify causes of components not working properly, there is some information in the diagnostic scan report which may be utilized to determine identifiers for various components. For example, information on the diagnostic scan report may include various identifiers which may identify parts and may be utilized to determine the interchangeability of the parts.

Information shown in embodiment 500 of FIGS. 5A and 5B may be determined by running a diagnostic scan of a vehicle, such as through the use of ODB2 scanner 200 of FIG. 2. The diagnostic scan report may include various items of “identification information” and corresponding values, such as identifier values. As shown, “Boot Software Part Number” may be associated with value, “86810821.” The Boost Software Part Number may indicate a version of software stored in the radio system. “Base Model Part Number” may be associated with identifier value, “84734075.” The Base Model Part number identifier may comprise a part number for a circuit board and various integrated circuits within a radio module. In an embodiment, a Tier 1 supplier may manufacture a base model with the circuit board and various integrated circuits and may provide the base model to an OEM, such as General Motors™, or some other vehicle manufacturer. The OEM may package the base model into a case to generate an “End Model” for the radio. For example, an End Model may comprise the Base Model as well as other components, such as bolts or wires for sealing the package in which the Base Model is packaged and for coupling the Base Model to an interior of the vehicle and electrically connecting the Base Model to circuitry within the vehicle. In embodiment 500, “End Model Part Number” may be associated with identifier value, “86810839.”

There is additional information relating to production dates and various other identifying information relating to the radio module. For example, “Control Module Production Date” may be associated with value, “26.07.2023.” “Diagnostic Data Identifier” may not be associated any value in embodiment 500. “Digital Radio Receiver ID” may be associated with identifier value, “4PRNKE8M.” “Manufacturer Enable Counter” may be associated with value, “0.” Circuitry within “End Model” may be programed with various software modules, to enable the radio module to perform various functions. Each software module may be associated with a particular identifier value. For example, “Software Module 1 Identifier” may be associated with identifier value, “86810823.” “Software Module 2 Identifier” may be associated with identifier value, “84684706.” “Software Module 3 Identifier” may be associated with identifier value, “84746971.” “Software Module 4 Identifier” may be associated with identifier value, “42767485.” “Software Module 5 Identifier” may be associated with identifier value, “84924650.” “Software Module 6 Identifier” may be associated with identifier value, “84915957.” “Software Module 7 Identifier” may be associated with identifier value, “84988778.” “Software Module 8 Identifier” may be associated with identifier value, “42788840.” “Software Module 9 Identifier” may be associated with identifier value, “84891421.” “Software Module 10 Identifier” may be associated with identifier value, “84682813.” “Software Module 11 Identifier” may be associated with identifier value, “84915955.” “Software Module 12 Identifier” may be associated with identifier value, “84720446.” “Software Module 13 Identifier” may be associated with identifier value, “42790932.” “Software Module 14 Identifier” may be associated with identifier value, “84635368.” “Software Module 15 Identifier” may be associated with identifier value, “84635371.” “VIN Digits 2-17” may be associated with identifier value, “G1ZD5STXRF106071.”

FIG. 5B additionally shows four DTCs associated with a circuit or system that includes electrical components, wiring, and/or software, to name just a few items among many. The DTCs may be related to some of the 16 identifiers, but other of the identifiers may be unassociated with any of the DTCs. A DTC itself may be stored in a control module, such as “Radio”, for example. A DTC may relate to one of the 16 identifiers, or it may relate to none of them, e.g., in some instances, the DTC may relate to an electrical component elsewhere in the circuit or system. Any of the identifiers which are not associated with any of the DTCs may be determined to be in reusable condition. However, if any of the DTCs are associated with any of the 16 identifiers are listed in the diagnostic scan report of embodiment 400, additional sources of information may be utilized to determine whether any of the associated software modules are likely reusable.

It should be appreciated that in some instances, an end model part number for a module may change with each new version of the vehicle. For example, an End Model Part number for a radio module in a 2024 General Motors™ vehicle may be different than an End Model Part number for a radio module in 2025 General Motors™ vehicle even in scenarios in where the circuitry board and integrated circuits of a Base Model are the same for 2024 and 2025 General Motors™ vehicles. In some cases, the only difference between the 2024 and 2025 versions of the radio module might be the software modules programmed into the radio module. Accordingly, if a part number for a radio module is determined and associated with a 2024 version, a determination may be made as to which software modules should be updated in order to repurpose the radio module for use in a 2025 General Motors™ vehicle, for example.

When installing a module within a vehicle, various software updates may typically be performed to ensure compatibility with other components of the vehicle. Accordingly, a 2024 version of the radio module may therefore be repurposed for installation within a 2025 vehicle and, after installation, the software for the radio module may be updated.

In some cases, a service part number may be listed within an electronics part catalog for a radio module, or for some other module. The service part number might not be the same as the End Part Number for the radio module in some instances. The part number identifiers in the diagnostic scan report indicate the part numbers for various components, as they were designated when the module was originally installed within the vehicle. In other words, the numbering system within an electronics parts catalog may differ from the identifier numbers determined from interrogating the control system of a vehicle.

A recycler would need to have both part numbers, including a part number listed in an electronic parts catalog, as well as a part number determined from a diagnostic scan report. By having both part numbers for the same component, a recycler may be able to determine compatibility and interchangeability of a part between vehicles, for example.

There are different levels of interchangeability. In a first level of interchangeability, a component from one vehicle has the same hardware and software that another vehicle is expecting. Such a level of interchangeability may be considered a “plug-and-play” level of interchangeability. Accordingly, such a component may be removed from the first vehicle and installed in the second vehicle without updating anything.

In a second level of interchangeability, the a component removed from the first vehicle may include the hardware and the physical dimensions expected by the second vehicle, but the software modules programmed thereon may be different. In such a case, the component may be usable in the second vehicle if the software modules are updated and/or reconfigured to include what the second vehicle is expecting the component to have. In various implementations, most components are more likely to have the second level of interchangeability than the first level of interchangeability.

In some implementations, a component having the first level of interchangeability may be more valuable than a component having the second level of interchangeability because nothing would need to be updated or reconfigured for a component having the first level of interchangeability. Accordingly, a parts supplier or reseller may have an ability to charge a higher price for components having the first level of interchangeability.

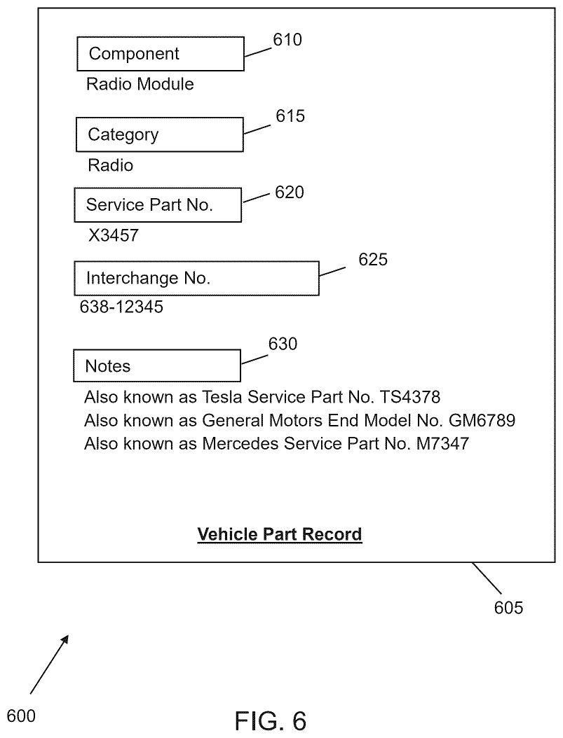

FIG. 6 illustrates an embodiment 600 of an example of a record 605 which may be stored in a database for a particular vehicle component. For example, vehicle parts availability database 340 of embodiment 300 of FIG. 3 may store a different record 605 for each vehicle component for which information is known or available for purchase. In this example, record 605 includes several sections, such as a component section 610, which may indicate a title or name of a particular vehicle component identified by record 605. In embodiment 605, component section 610 indicates that record 605 is for a “radio module.” A category section 615 may indicate a category of the radio module component which, in this example, is “radio.” A service part number section 620 may indicate a service part number employed by a manufacturer of the radio module for record 605, such as “X3457.” An interchange section 625 may indicate a part number for the radio module which may be different from the service part number employed by the manufacturer. For example, a dismantler and/or parts supplier may keep records for various vehicle parts available for purchase and that records may be searchable so that if someone is searching for a particular part number, that item may be identified. In this case, the dismantler and/or part supplier may employ a part numbering scheme which may be unique to that dismantler and/or part supplier. However, the dismantler and/or part supplier may instead employ a standardized part numbering scheme, such as those utilized by Hollander™. Hollander Interchange™ part numbers are used in the Hollander Interchange Manual™, a reference system for identifying interchangeable auto parts. These numbers help determine which parts from different vehicles can be used as replacements for one another. The Hollander Interchange™ system uses a 5-digit number to indicate potential interchangeability and a final alphabetic character to denote perfect interchangeability.

In embodiment 600, interchange part number section 625 may list a Hollander Interchange™ part number or some other designated part numbering scheme, such as “638-12345,” where the first three digits, “638,” correspond to the “radio” category and the remaining digits, “−12345” indicate the exact radio module of the vehicle part record 605. Record 605 may also include a notes section 630, in which cross-references with other part-numbering systems may be listed. For example, notes section 630 in embodiment 600 indicates that interchange part number “638-12345” and service part number “X3457” are also known as “Tesla Service Part No. TS4378,” “General Motors End Model No. GM6789,” and “Mercedes Service Part No. M7347.” By listing multiple part number identifiers for record 605, a person looking for a particular component may determine that interchange part number “638-12345” and service part number “X3457” corresponds to various Tesla™, General Motors™, and Mercedes™ part numbers.

Hollander Interchange™ part numbers are a unique numbering system used in the Hollander Interchange Manual™, which is a comprehensive guide for finding interchangeable automotive parts across different makes and models, primarily used in the auto salvage and recycling industry. These numbers are not found on the parts themselves but are derived from the manual, serving as a cross-reference to identify which parts from different vehicles can be used as replacements. A dismantler may remove a component from a vehicle being dismantled and may create a listing to market the component for resale. In a notes section of a listing for an item, the dismantler may list the corresponding part numbers for each vehicle known to use the same component. For example, if a component removed from a 2022 Cadillac™ may be usable in a 2024 Tesla™ and a 2025 Mercedes™, the dismantler may associate the Cadillac™ part number, the Tesla™ part number, and the Mercedes™ part number which corresponds to the Hollander Interchange™ service part number for the same item in a listing. These number different part numbers may be included within a listing to make a component discoverable by someone searching an electronic parts catalog.

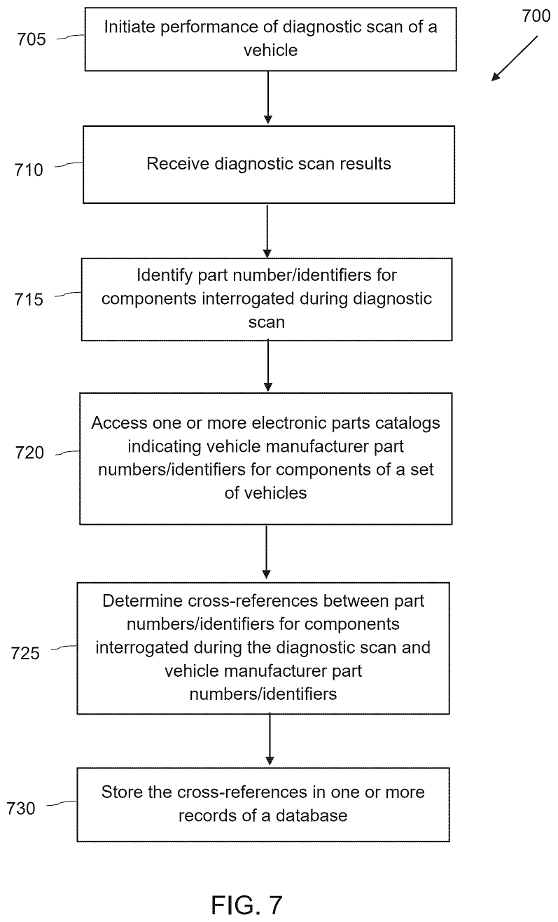

FIG. 7 illustrates an embodiment 700 of a flow diagram for determining interchangeability of one or more components of a vehicle. Embodiments in accordance with claimed subject matter may include all of, less than, or more than operations 705 through 730. Also, the order of operations 705 through 730 is merely an example order. For example, a method in accordance with embodiment 700 may be performed by a computing device having one or more processors.

At operation 705, performance of a diagnostic scan may be initiated. For example, a diagnostic scan of a 2023 General Motors Silverado™ may be initiated. At operation 710, diagnostic scan results may be received from the vehicle after completion of the diagnostic scan. For example, the diagnostic scan results may be organized in the form of a report indicating information for various systems interrogated during the diagnostic scan.

At operation 715, part number/identifiers may be identified for components interrogated during diagnostic scan. For example, as discussed above with respect to FIGS. 5A and 5B, a diagnostic scan may indicate part number/identifiers for various components which have been interrogated. At operation 720, one or more electronic parts catalogs may be accessed which indicate vehicle manufacturer part numbers/identifiers for components of a set of vehicles, such as a set of vehicles which have previously been scanned or for which components have previously been determined or identified, for example. An electrical parts catalog is not necessary controlled, licensed, developed, or owned by a vehicle manufacturer. For example, an electronic parts catalog may be developed independent of a vehicle manufacturer.

At operation 725, cross-references may be determined between part numbers/identifiers for components interrogated during the diagnostic scan and vehicle manufacturer part numbers/identifiers. The cross-references may be utilized to determine interchangeability of a particular component within various different models and years of manufacture of vehicles. At operation 730, the cross-references may be stored in one or more records of a database, such as those discussed above with respect to embodiment 600 of FIG. 6. For example, the one or more records may be those stored in one or more electronic parts databases.

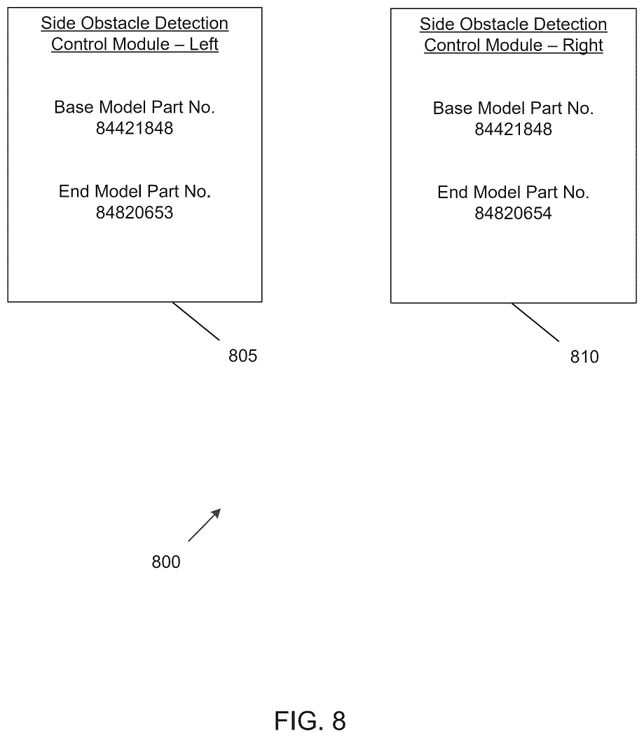

FIG. 8 illustrates an embodiment 800 of two control modules of a vehicle which have the same end model part number, but different base model part numbers. Embodiment 800 includes a Side Obstacle Detection Control Module—Left 805 and a Side Obstacle Detection Control Module—Right 810. In embodiment 800, each of the Side Obstacle Detection Control Module-Left 805 and a Side Obstacle Detection Control Module—Right 810 may include two different part numbers listed thereon. For example, Side Obstacle Detection Control Module—Left 805 lists a Base Model Part. No. 84421848 and an End Model Part No. 84820653. In some embodiments, the End Model Part No. may comprise an assembly part number which is determined by the automobile manufacturer, such as General Motors™ or Ford™, whereas the Base Model Part No. may comprise a part number determined by a Tier 1 supplier which manufactured the Side Obstacle Detection Control Module—Left 805 and provided the component to the vehicle manufacturer. Similarly, Side Obstacle Detection Control Module—Right 810 lists a Base Model Part. No. 84421848 and an End Model Part No. 84820654. In this example, if someone searched in an electronic parts catalog for a part number for a replacement Side Obstacle Detection Control Module—Left 805, only the End Model Part No. may be displayed to the person. Accordingly, even though the Side Obstacle Detection Control Module—Left 805 and the Side Obstacle Detection Control Module—Right 810 are associated with different End Model Part Nos., they are both associated with the same Base Model Part No. 84421848. Therefore, Side Obstacle Detection Control Module—Left 805 with Base Model Part. No. 84421848 may be removed from one vehicle and installed in a different vehicle which requires a replacement Side Obstacle Detection Control Module—Right 810 having End Model Part No. 84820654. In other words, even though these two modules have different End Model Part Nos., they have the same Base Model Part No. because they are the same underlying modules and are therefore interchangeable. However, if a vehicle repairperson was unaware that the Side Obstacle Detection Control Module—Left 805 and the Side Obstacle Detection Control Module—Right 810 use the same Base Model Part No, then the repairperson may not know that Side Obstacle Detection Control Module—Left 805 may be installed in the place of a missing or damaged Side Obstacle Detection Control Module—Right 810 on a different vehicle. In some implementations, only the End Model Part No. may be printed directly on a module or the module may not be easily accessible for a repairperson to read part numbers printed thereon, in which case there may be no simple way for the repairperson to know or determine a Base Model Part No. for either the Side Obstacle Detection Control Module—Left 805 or the Side Obstacle Detection Control Module—Right 810 unless some other party has previously determined the interchangeability of these parts, such as by identifying the Base Model Part Nos. from a diagnostic scan.

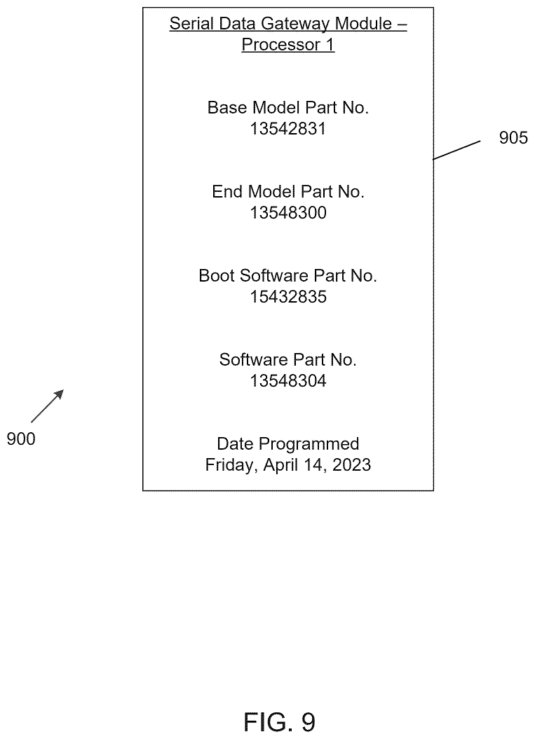

FIG. 9 illustrates an embodiment 900 of various items of information associated with a module, such as a Serial Data Gateway Module 905. In embodiment 900, a Base Model Part. No. 15542831, an End Model Part No. 13548300, a Boot Software Part No. 15432835, and a Software Part No. 13548304 may be associated with Serial Data Gateway Module 905. For example, if a diagnostic scan is performed on a vehicle in which Serial Data Gateway Module 905 is installed, each of these part numbers may be listed in the diagnostic scan results. For example, the Base Model Part No. may comprise a part number determined by a Tier 1 supplier of the circuitry of the Serial Data Gateway Module 905. A vehicle manufacturer may package the Serial Data Gateway Module 905 within a case or box, where the case or box is associated with the End Model Part No. The Boot Software Part No. may indicate a version of boot software installed in the Serial Data Gateway Module 905. The Boot Software Part No. refers to the low-level firmware or software that initializes and manages the startup process (booting) of an ECU or module, such as in a General Motors™ vehicle. The boot software is responsible for loading the main operating software and ensuring the hardware is properly initialized. The Software Part No. may indicate a version of software installed in the Serial Data Gateway Module 905. The Software Part No. refers to the main application software or firmware that runs on the ECU to control specific vehicle functions, such as engine management, transmission control, infotainment, or advanced driver assistance systems (ADAS). Information within a diagnostic scan may additionally indicate a date on which software (e.g., boot software or non-boot software) in the Serial Data Gateway Module 905 was programmed and/or updated, which in which case is Apr. 14, 2023. It is the most recent date that any software (Boot or non-Boot) was updated.

The determination of multiple different identifiers associated with Serial Data Gateway Module 905 may be used as factors in determining whether one electrical component of a vehicle is interchangeable with another electrical component. The date of programming may be useful, in some implementations, because overtime software may be updated (e.g., for maintenance, enhancement of function, expansion of the set of chassis supported, enhancement of performance, etc.) and thus may also be used as a factor in determining whether one electrical component of a vehicle is interchangeable with another electrical component.

Determining the interchangeability of two electrical components can be learned by trial and error: replace one electrical component with a second; observe the Health Response or another indication of health; and use the findings as feedback to learn about the interchangeability. This may be particular beneficial in a case where an identification number or other attribute communicated from a circuit or system in one vehicle is not an exact match for an identification number or attribute communicated from a second vehicle (e.g., in the time between the assembly of vehicle one and two, an identification number has been superseded, a bracket has additional mounting holes to accommodate new vehicles introduced since the assembly of vehicle one).

A benefit of using one or more attributes communicated during the diagnostic scan (e.g., identification number, timestamp) as factors in identifying an electrical component that is interchangeable with another electrical component is not requiring the identification number used by a vehicle manufacturer when it provides a part to a repair workshop.

Determined the interchangeability of two electrical components can also be learned without directly observing the Health Response or another indication of health by observing, for a first electrical component, the warranty return volume, sales volume, merchandising attributes, other commercial data about it or its associated vehicle under repair attributes and comparing against a second electrical component that is an inexact match for an identification number or attribute communicated by the first electrical component.

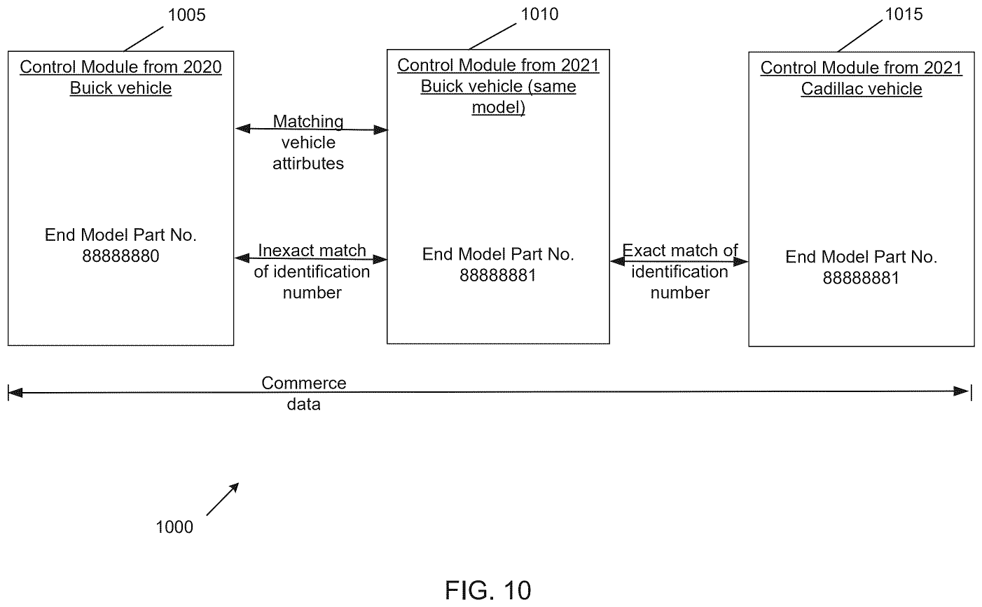

FIG. 10 illustrates an embodiment 1000 indicating interchangeability of control modules of three different vehicles. For example, a Control Module 1005 from a 2020 Buick vehicle may be associated with End Model Part No. 88888880, a Control Module 1010 from a 2021 Buick vehicle (the same model but from a different model year) may be associated with End Model Part No. 88888881, and a Control Module 1015 from a 2021 Cadillac vehicle may be associated with End Model Part No. 88888881. Accordingly, Control Module 1010 from the 2021 Buick vehicle and the Control Module 1015 from the 2021 Cadillac vehicle are each associated with the same End Model Part No. 88888881. However, although the 2020 Buick and the 2021 Buick vehicles are the same vehicle model, but from different years, there is an inexact match in the end Model Part Nos. associated with Control Module 1005 and Control Module 1010, where the first seven digits of the End Model Part No. are identical but the eight digit is different.

Interchangeability of two electrical components may also be learned without directly observing a diagnostic scan or another indication of health by observing, for a first electrical component, certain commerce-related information such as warranty return volume, sales volume, merchandising attributes, other commercial data about the first electrical component or its associated vehicle under repair attributes and comparing such commerce data against a second electrical component that is an inexact match for an identification number or attribute communicated by the first electrical component. Embodiment 1000 of FIG. 10 shows an example of commerce data (e.g., sales volume, warranty returns) determining that identification number 88888880 is superseded by identification number 88888881 (which now supports both Buick™ and Cadillac™). An electrical component having identification number 8888880 may therefore be replaced with an electrical component having identification number 8888881.

In other words, instead of solely using data from a diagnostic scan, other data about parts sold from a dismantler to a repair workshop may be considered, as well as information about whether the part was subsequently returned by the repair workshop to a dismantler because it did not work. If 88888881 is sold to a repair workshop to fix a 2020 Buick™ and the workshop does not subsequently return 88888881 under warranty, then that is a signal that components with part numbers 88888881 and 88888880 are interchangeable.

Embodiments as described above may utilize diagnostic scans of a vehicle to determine identifiers for various components and, subsequently, interchangeability of such components. Information presented in diagnostic scans may be utilized for additional reasons, such as to help identify a category for a vehicle component within the Hollander Interchange™ system. Industries such as automotive recycling often employ a standardized numbering scheme to designate the identification number for a component of an automotive vehicle. For example, the identification number may incorporate a category of component.

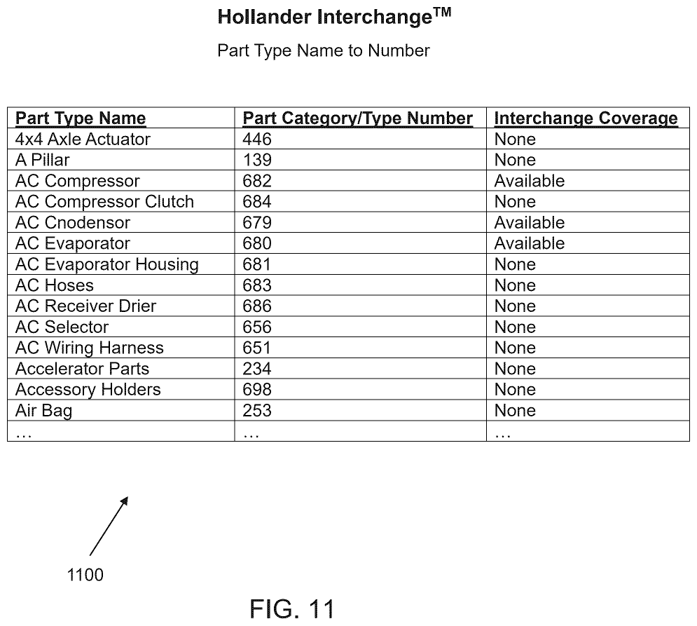

FIG. 11 illustrates an embodiment of a portion of a list part names and associated part numbers for various vehicle components. For example, a “4×4 Axle Actuator” is associated with a part category/type number “446.” Similarly, “A Pillar” is associated with part category/type number “139,” and “AC Compressor” is associated with part/category number “682.” The part category/type numbers may be employed within the automobile recycling industry to determine stock keeping units (SKUs) for each part dismantled from a vehicle and/or available for sale and use in a different vehicle. An identification number for an SKU of an air conditioning (AC) compressor for a vehicle might be 682-10001, 682-10002, or 682-10003, to name just a few examples among many.

In some cases, time is of essence when determining a category of stock keeping unit. For example, at the time an automotive recycler identifies the parts on a vehicle for entry into an inventory, it is beneficial to find the category of an SKU in real time so that: (i) an inventory record can be made without delay, (ii) a decision whether to immediately remove a part from a vehicle can be made without delay; or (iii) a buyer can make an offer to purchase the part without delay, to name just a few examples among many.

In order to identify a category for a SKU likely to be associated with a particular component, such as an electrical component, various indications of the likely category may be identified and used to infer a likely category. For example, if a particular module is associated with a particular identification number known to normally be associated with a particular category, a determination may be made that the module also belongs to the same category, for example.

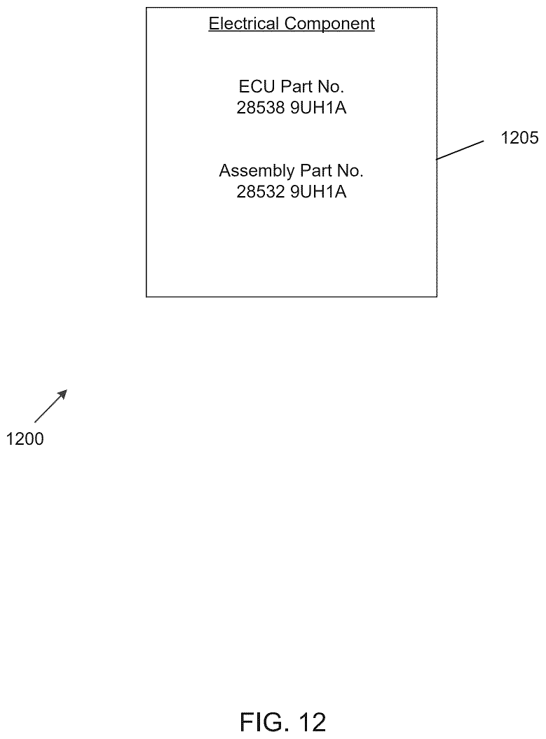

FIG. 12 illustrates an embodiment 1200 of an electrical component 1205 of a vehicle for which a category of the part or component is unknown. In embodiment 1200, electronic component 1205 may comprise a sonar controller of a vehicle. However, it may not be readily apparent simply from looking at electronic component 1205 that electronic component 1205 is such a sonar controller if, for example, electrical component 1205 does not have the text “Sonar Controller” printed on a body thereof or if the electrical component 1205 is not easily accessible for manual inspection. In this case, certain other information may be printed on a body of electrical component 1205, such “ECU Part No. 28538 9UH1A” or “Assembly Part No. 28532 9UH1A”. A Hollander Interchange™ part category for a Sonar Controller is 591, but if a technician simply looking at a body of electrical component 1205 is unaware that the electrical component 1205 is a Sonar Controller, the technician may not be aware that the electrical component 1205 belongs to Hollander Interchange™ part category 591.

Similarly, if one wanted to know the category of stock keeping unit in which the vehicle manufacturer considers the part to be, it is not obvious that it is 28538 when referring to the electronic control unit (ECU) itself and 28532 when referring to the assembly of ECU, mounting bracket, fastener, et al. In this case, the identification numbers have the same suffix, “9UH1A” in the ECU Part No. and the Assembly Part No.

Instead of having to manually inspect an electrical component or module to determine identifying information, such as part numbers or a part name, a diagnostic scan may be performed on a vehicle to identify various electrical components, such as modules within the vehicle, such as is described above with resect to FIG. 3 and FIGS. 4A-4B. Part numbers for an electrical component interrogated during a diagnostic scan may be utilized to identify categories for the various electrical components for which identifiers have been received and listed in the diagnostic scan results, such as those shown in embodiment 400.

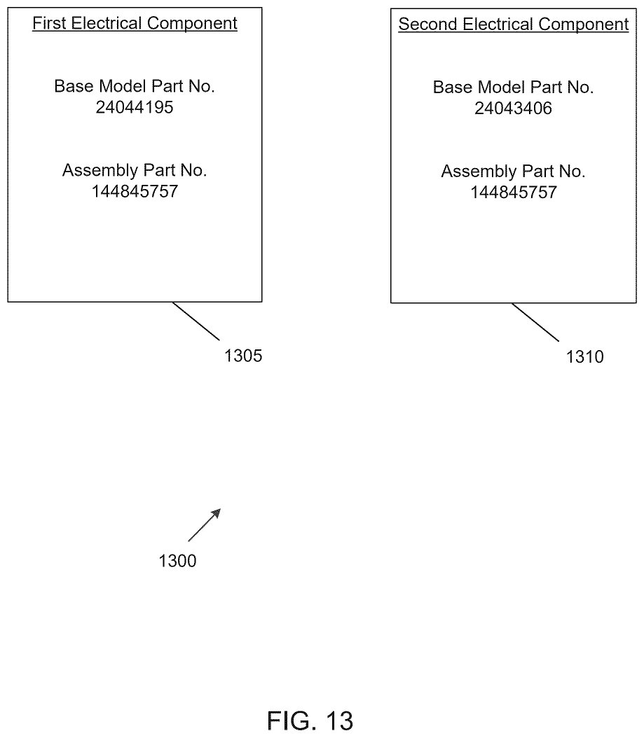

FIG. 13 illustrates an embodiment 1300 in which part categories for two electrical components may be determined. In embodiment 1300, a first electrical component 1305 may be associated with Base Model Part No. “24044195” and Assembly Part No. “144845757.” A second electrical component 1310 may be associated with Base Model Part No. “24043406” and Assembly Part No. “144845757.” Accordingly, the Assembly Part No. or subcategory for each electrical component is “144845757.” It may therefore be determined that because the first electrical component 1305 and the second electrical component 1310 are both associated with the same Assembly Part No., then these components also likely belong to the same product category. By knowing the part category of the first electrical component 1305 and knowing its subcomponent (e.g., indicated by the Assembly Part No.) is also in the second electrical component 1310 means that a category of the second electrical component 1310 is likely to be the same as the category of the first electrical component 1305.

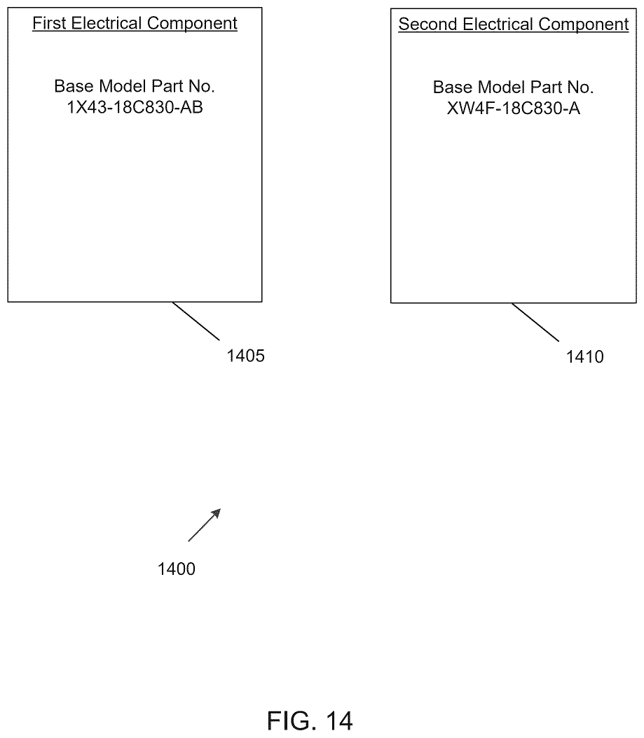

FIG. 14 illustrates an embodiment 1400 in which part categories for two electrical components may be determined. In embodiment 1400, a first electrical component 1405 may be associated with Base Model Part No. “1X43-18C830-AB” and a second electrical component 1410 may be associated with Base Model Part No. “XW4F-18C830-A”. It should be appreciated that the Base Model Part Nos. for first electrical component 1405 and second electrical component 1410 may be obtained by performing a diagnostic scan of vehicles in which first electrical component 1405 and second electrical component 1410 are disposed or installed. The scheme of these identification numbers includes the vehicle manufacturer's identification number for the category of SKU in the string of character between the hyphens, e.g., “18C830” is the category. For example, it may be known in the industry, that “18C830” indicates a category of a SKU. Despite not knowing what the category 18C830 is, one may determine that the category of the first electrical component and the second electrical component are likely the same. Accordingly, if a part category for second electrical component 1310 is already known, then a determination may be made that first electrical component 1305 likely belongs to the same part category.

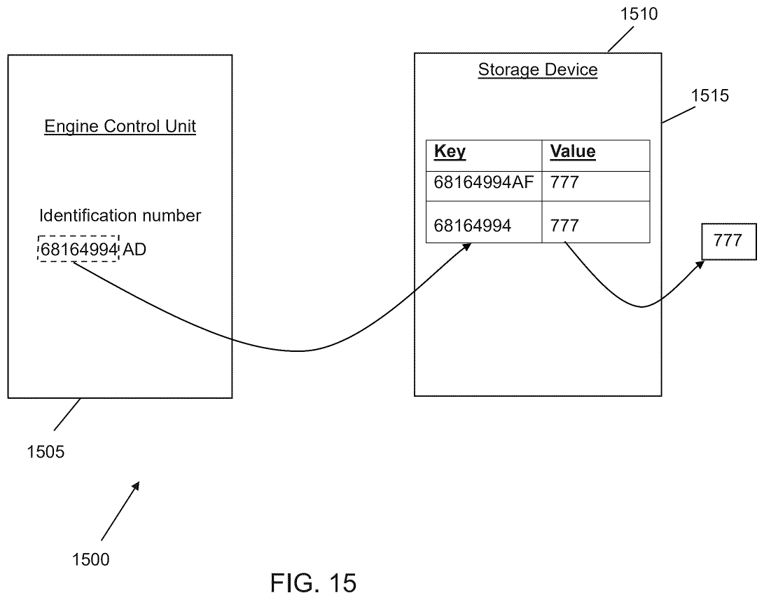

FIG. 15 illustrates an embodiment 1500 of an association between an Engine Control Unit (ECU) 1505 and a key-value pair. In embodiment 1500, ECU 1505 may be associated with identification number “68164994AD”. A storage device 1510, such as a database, may store key-value pairs comprising associations between identification numbers and part category numbers in a key-value pair map 1515. In embodiment 1500, it may be known that the last two characters of an identification number for a particular electronic component indicate a change level of the electronic component, sch as where “A” refers to a first change level, “B” refers to a second change level, . . . “AA” refers to the twenty-seventh change level, and so forth. In embodiment 1500, there is information stored in storage device 1510 which indicates that an electrical component with identification number “68184994AF” is associated with part category number “777.” If it is know that the suffix for the identification number refers to the change level, then it may be determined that because the first portion of the identification number other than the suffix for ECU 1505 is the same as a value stored in key-value pair map 1515 of storage device 1510, then the ECU 1505 is likely associated with the same part category, “777.”

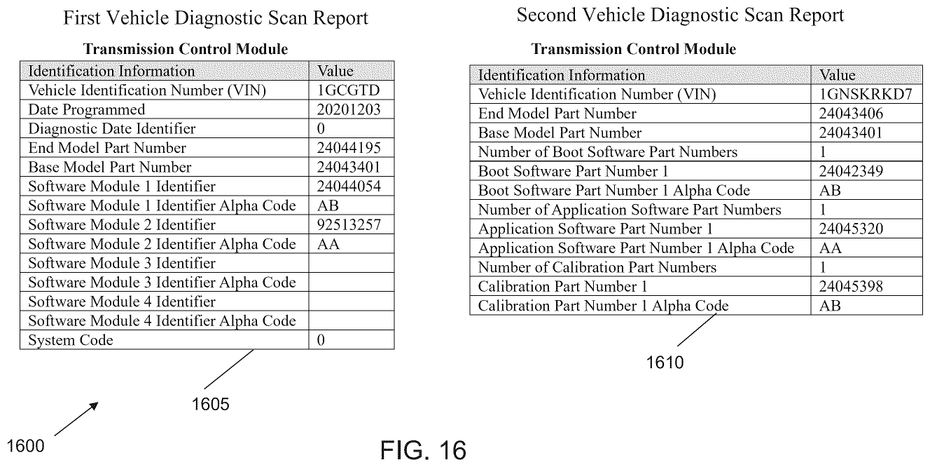

FIG. 16 illustrates an embodiment 1600 of diagnostic scan reports for two different vehicles. For example, embodiment 1600 includes a first vehicle diagnostic scan report 1605 and a second vehicle diagnostic scan report 1610. First vehicle diagnostic scan report 1605 may contain some category items which are different from those of second vehicle diagnostic scan report 1610 because, for example, one of the vehicles may have been sold with features or options and the other was not, e.g., such as a front wheel drive versus an all-wheel drive feature. In embodiment 1600, there are different identifiers for the first vehicle diagnostic scan report 1605 and the second diagnostic scan report 1610 for various categories. However, both of the first diagnostic scan report 1605 and the second diagnostic scan report 1610 list the same Base Model Part Number, “24043401.” Accordingly, any determinations of categories for parts in the Transmission Control Module of the first vehicle may be the same as the categories for parts in the Transmission Control Module of the second vehicle because they both are associated with the same Base Model Part Number.

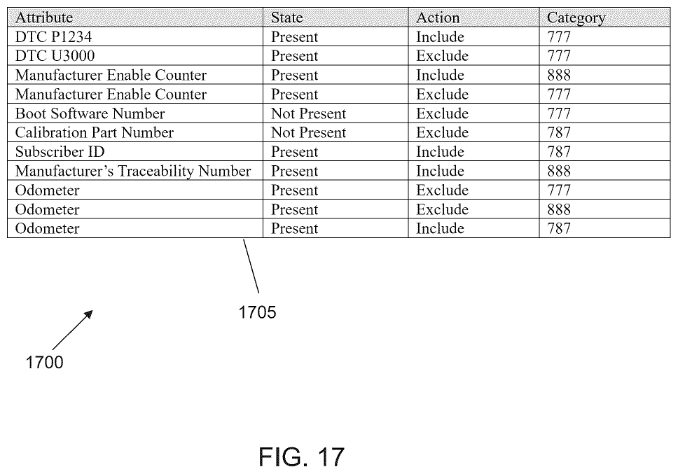

FIG. 17 illustrates an embodiment 1700 of a chart 1705 of attributes of a vehicle component and associated part category numbers. As shown, chart 1705 includes several categories, such as “Attribute,” “State,” “Action,” and “Category,” to name just a few examples of items which may be included in an attribute chart. Chart 1705 may be utilized to determine a category of SKU for an electrical component based on information contained in a diagnostic scan report. For example, a diagnostic scan report might output diagnostic trouble code (DTC) “P1234” or DTC “U3000” for a circuit or system. The “Action” column of chart 1705 indicates whether a particular category should be included as possibly being associated with a particular attribute or whether the category should be excluded from consideration, such as where it is known that the category is unrelated to the attribute. Based on an analysis of previously determined category information, it may be known that it is possible for a circuit or system having an electrical component in category 777 to report DTC P1234. Similarly, it may also be known that it is impossible for a circuit or system having an electrical component in category 777 to report DTC U3000. This knowledge stored as records in a database may be used to predict/infer whether a category is included or excluded for the set of categories of which an electrical component might be a member. Other information from a diagnostic scan result that may also be used in a similar manner may include “Manufacturer Enable Counter,” “Odometer,” “Manufacturer's Traceability Number,’ and ‘Subscriber ID,” for example.

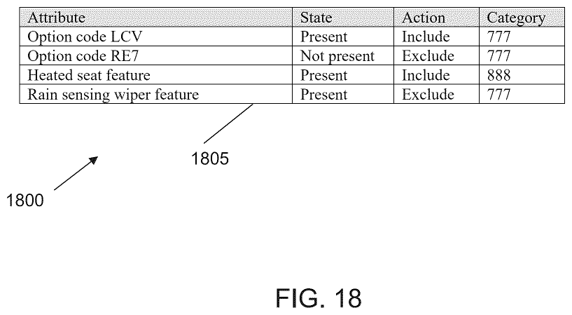

FIG. 18 illustrates an embodiment 1800 of a chart 1805 of attributes of a vehicle component and associated part category numbers. As shown, chart 1805 may include data about features and options as built on a specific automotive vehicle. This information might be gathered during a diagnostic scan or another way (e.g., by optically reading an option label for a vehicle, or electronically receiving the features and options from vehicle manufacturer data about the vehicle as built). Knowledge about the absence or presence of a feature or option may be useful for predicting whether a category is included or excluded for the set of categories of which the electrical component might be a member.

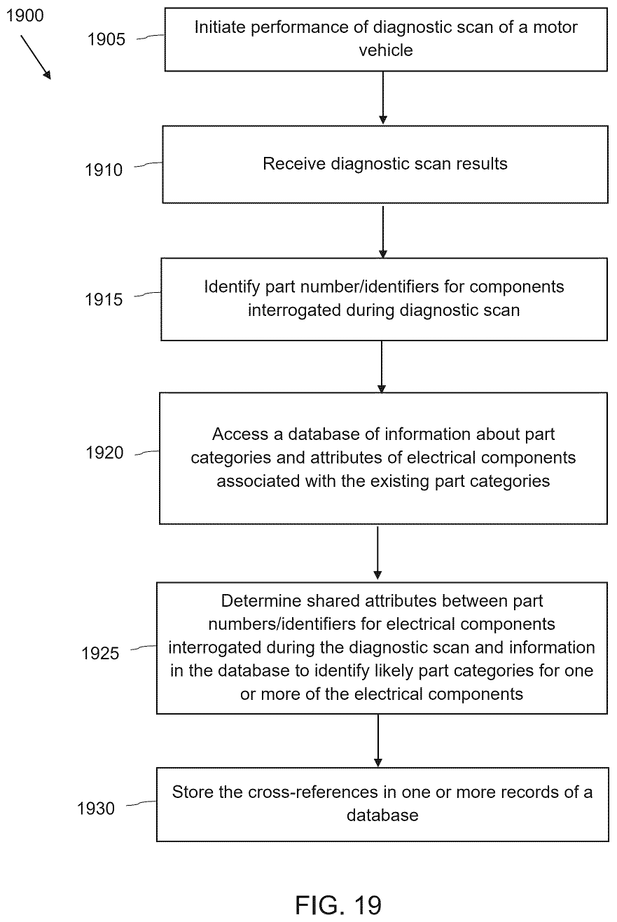

FIG. 19 illustrates an embodiment 1900 of a flow diagram for determining a likely part category for one or more components of a vehicle. Embodiments in accordance with claimed subject matter may include all of, less than, or more than operations 1905 through 1930. Also, the order of operations 1905 through 1930 is merely an example order. For example, a method in accordance with embodiment 1900 may be performed by a computing device having one or more processors.

At operation 1905, performance of a diagnostic scan of a vehicle may be initiated. At operation 1910, diagnostic scan results may be received from the vehicle after completion of the diagnostic scan. For example, the diagnostic scan results may be organized in the form of a report indicating information for various systems interrogated during the diagnostic scan.

At operation 1915, part number/identifiers may be identified for components interrogated during diagnostic scan. For example, as discussed above with respect to FIGS. 5A and 5B, a diagnostic scan may indicate part number/identifiers for various components which have been interrogated. At operation 1920, a database of information about part categories and attributes of electrical components associated with the existing part categories may be accessed.

At operation 1925, shared attributes may be determined between part numbers/identifiers for electrical components interrogated during the diagnostic scan and information in the database to identify likely part categories for one or more of the electrical components. At operation 1930, the identified likely part categories for one or more of the electrical components in one or more records of a database.

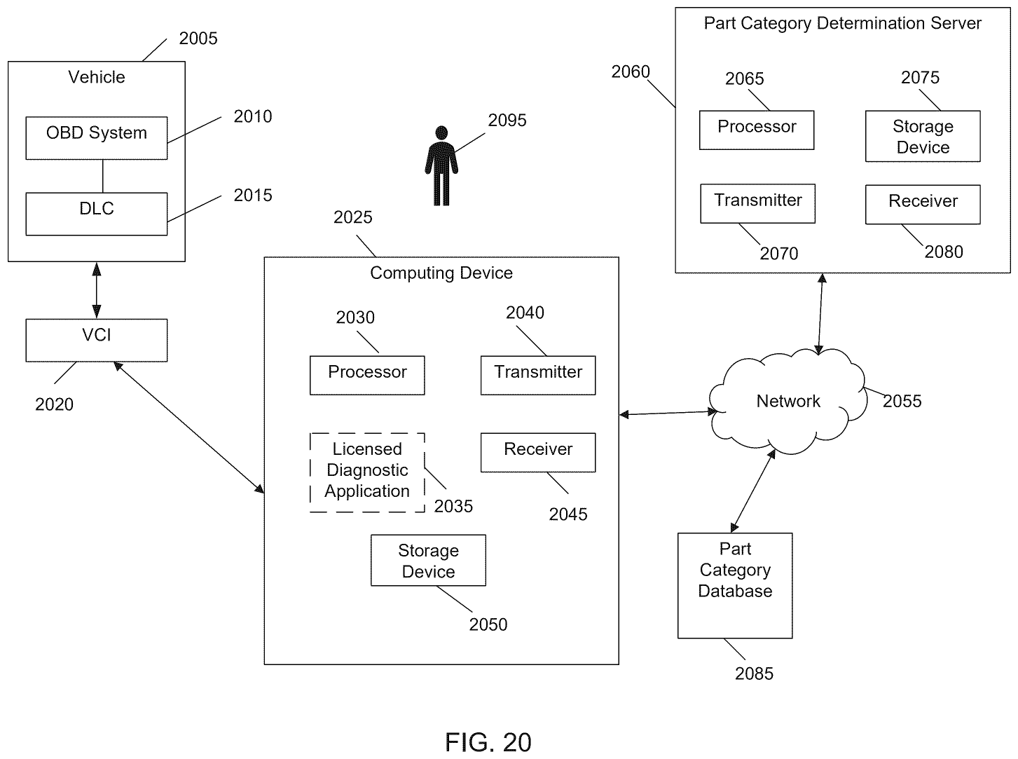

FIG. 20 illustrates an embodiment 2000 of a system for determining a likely part category for one or more electrical components or modules of a vehicle 2005. For example, a part category may comprise a category within the Hollander Interchange™ system. A user 2095, such as an automobile repair technician may utilize a computing device 2025, such as a laptop computer, a desktop computer, a smart phone, smart tablet, or any other computing device capable of launching and running a licensed diagnostic application 2035, such as an application specific to a certain vehicle manufacturer such as a General Motors™, Ford™, or Honda™, to name just a few examples among many. For example, if vehicle 2005 is a General Motors™ automobile, licensed diagnostic application 2035 may be dedicated for use with General Motors™ automobiles. User 2095 may provide one or more user inputs via licensed diagnostic application 2035 to cause VCI 2020 to provide a request for a diagnostic scan to an On-Board Diagnostic (OBD) system 2010 via a DLC 2015 of vehicle 2005. Results of the requested diagnostics scan of vehicle 2005 may be transmitted from OBD system 2010 via DLC 2015 and from VCI 2020 to licensed diagnostic application 2035. Licensed diagnostic application 2035 may generate a diagnostic scan result, such as a file indicating results of the diagnostic scan of vehicle 2005, and the diagnostic scan result may be stored in a storage device 2050 of computing device 2025. Although storage device 2050 is illustrated as being internal to computing device 2025, it should be appreciated that in some implementations, storage device 2050 may be external to, but still accessible by, computing device 2025.

Computing device 2025 may include a processor 2030, a transmitter 2040, and a receiver 2045. Processor 2030 may execute instructions or program code stored in storage device 2050, for example. Receiver 2045 may receive messages or other communication transmitted to computing device 2025, and transmitter 2040 may transmit messages or other communication from computing device 2025. Computing device 2025 may be in communication with a reusability determination server 2060 such as via a network 2055, such as the Internet. Reusability determination server 2060 may include a processor 2065, a transmitter 2070, a storage device 2075, and a receiver 2080, to name just a few potential components, among many, of reusability determination server 2060. Part category determination server 2060 may receive a diagnostic scan result or report from computing device 2025 for vehicle 2005 and may attempt to identify or otherwise determine likely product or part categories for electrical components or modules of vehicle 2005 interrogated during the diagnostic scan, such as those electrical components in usable condition for harvesting from vehicle 2005 and reuse in another vehicle. As discussed above, part category determination server 2060 may make a determination of likely part categories for electrical components based common attributes identified between information in the diagnostic scan and information in a part category database 2085. For example, information in part category database 2085 may include part numbers associated with particular product categories and/or other vehicle component features associated with the product categories. Processor 2065 of part category determination server 2060 may execute instructions or program code stored in storage device 2075 to make such a determination, for example.

Although embodiment 2000 is described with respect to use of a part category determination server 2060 and a part category database 2085, it should be appreciated that embodiment 2000 may be modified to include an interchangeability determination server and an electronic parts catalog server to determine interchangeability of electrical components of a vehicle, such as described above with respect to embodiments 400 and 700, for example.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

Some portions of the detailed description are presented herein in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

It has proven convenient at times, principally for reasons of common usage, to refer to such signals as bits, data, values, elements, symbols, characters, terms, numbers, numerals, files or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

It should be understood that for ease of description, a network device (also referred to as a networking device) may be embodied and/or described in terms of a computing device. However, it should further be understood that this description should in no way be construed that claimed subject matter is limited to one embodiment, such as a computing device and/or a network device, and, instead, may be embodied as a variety of devices or combinations thereof, including, for example, one or more illustrative examples.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics. Likewise, the term “based on” and/or similar terms are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn.

A network may also include now known, and/or to be later developed arrangements, derivatives, and/or improvements, including, for example, past, present and/or future mass storage, such as network attached storage (NAS), a storage area network (SAN), and/or other forms of computing and/or device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be substantially compliant and/or substantially compatible with differing protocols, such as computing and/or communication protocols (e.g., network protocols), may interoperate within a larger network. In this context, the term sub-network and/or similar terms, if used, for example, with respect to a network, refers to the network and/or a part thereof. Sub-networks may also comprise links, such as physical links, connecting and/or coupling nodes, such as to be capable to transmit signal packets and/or frames between devices of particular nodes, including wired links, wireless links, or combinations thereof. Various types of devices, such as network devices and/or computing devices, may be made available so that device interoperability is enabled and/or, in at least some instances, may be transparent to the devices. In this context, the term transparent refers to devices, such as network devices and/or computing devices, communicating via a network in which the devices are able to communicate via intermediate devices of a node, but without the communicating devices necessarily specifying one or more intermediate devices of one or more nodes and/or may include communicating as if intermediate devices of intermediate nodes are not necessarily involved in communication transmissions. For example, a router may provide a link and/or connection between otherwise separate and/or independent LANs. In this context, a private network refers to a particular, limited set of network devices able to communicate with other network devices in the particular, limited set, such as via signal packet and/or frame transmissions, for example, without a need for re-routing and/or redirecting transmissions. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet, for example. Although signal packet and/or frame transmissions may employ intermediate devices of intermediate nodes to exchange signal packet and/or frame transmissions, those intermediate devices may not necessarily be included in the private network by not being a source or destination for one or more signal packet and/or frame transmissions, for example. It is understood in this context that a private network may provide outgoing network communications to devices not in the private network, but devices outside the private network may not necessarily be able to direct inbound network communications to devices included in the private network.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A process for determining interchangeability of one or more electrical components of a particular motor vehicle, the process comprising:
initiating performance of a diagnostic scan of the particular motor vehicle;
receiving results of the diagnostic scan;
identifying one or more service part numbers/identifiers for electrical components interrogated during the diagnostic scan;
accessing one or more electronic parts catalogs indicating vehicle manufacturer part numbers/identifiers for electrical components of a set of vehicles;
determining one or more cross-references between the service part numbers/identifiers for electrical components interrogated during the diagnostic scan and the vehicle manufacturer part numbers/identifiers; and
storing the cross-references in one or more records of a database.

2. The process of claim 1, wherein the electrical components interrogated during the diagnostic scan comprise one or more electronic modules.

3. The process of claim 1, further comprising initiating performance of diagnostic scans of additional motor vehicles having different makes and models.

4. The process of claim 1, further comprising identifying one or more service part numbers/identifiers for hardware components interrogated during the diagnostic scan.

5. The process of claim 1, further comprising identifying one or more service part numbers/identifiers or installation, configuration, or update dates for software components interrogated during the diagnostic scan.

6. The process of claim 1, wherein the cross-references indicate interchangeability between the electrical components.

7. A system comprising:
an interchangeability determination server having a processor to:
initiate performance of a diagnostic scan of a particular motor vehicle;
receive results of the diagnostic scan;
identify one or more service part numbers/identifiers for electrical components interrogated during the diagnostic scan;
access one or more electronic parts catalogs indicating vehicle manufacturer part numbers/identifiers for electrical components of a set of vehicles;
determine one or more cross-references between the service part numbers/identifiers for electrical components interrogated during the diagnostic scan and the vehicle manufacturer part numbers/identifiers; and
store the cross-references in one or more records of a database.

8. The system of claim 7, wherein the electrical components interrogated during the diagnostic scan comprise one or more electronic modules.

9. The system of claim 7, wherein the processor is to further initiate performance of diagnostic scans of additional motor vehicles having different makes and models.

10. The system of claim 7, wherein the processor is to further identify one or more service part numbers/identifiers for hardware components interrogated during the diagnostic scan.

11. The system of claim 7, wherein the processor is to further identify one or more service part numbers/identifiers or installation, configuration, or update dates for software components interrogated during the diagnostic scan.

12. The system of claim 7, wherein the cross-references indicate interchangeability between the electrical components.

13. An article, comprising:
a non-transitory storage medium comprising machine-readable instructions executable by a processor to perform a process for determining interchangeability of one or more electrical components of a particular motor vehicle, the process comprising:
initiating performance of a diagnostic scan of the motor vehicle;
receiving results of the diagnostic scan;
identifying one or more service part numbers/identifiers for electrical components interrogated during the diagnostic scan;
accessing one or more electronic parts catalogs indicating vehicle manufacturer part numbers/identifiers for electrical components of a set of vehicles;
determining one or more cross-references between the service part numbers/identifiers for electrical components interrogated during the diagnostic scan and the vehicle manufacturer part numbers/identifiers; and
storing the cross-references in one or more records of a database.

14. The article of claim 13, wherein the electrical components interrogated during the diagnostic scan comprise one or more electronic modules.

15. The article of claim 13, wherein the machine-readable instructions are further executable by the processor to initiate performance of diagnostic scans of additional motor vehicles having different makes and models.

16. The article of claim 13, wherein the machine-readable instructions are further executable by the processor to identify one or more service part numbers/identifiers for hardware components interrogated during the diagnostic scan.

17. The article of claim 13, wherein the machine-readable instructions are further executable by the processor to identify one or more service part numbers/identifiers or installation, configuration, or update dates for software components interrogated during the diagnostic scan.

18. The article of claim 13, wherein the cross-references indicate interchangeability between the electrical components.

19. A process for determining a part category of one or more electrical components of a motor vehicle, the process comprising:
initiating performance of a diagnostic scan of the motor vehicle;
receiving results of the diagnostic scan;
identifying one or more service part numbers/identifiers or attributes for electrical components interrogated during the diagnostic scan;
accessing a database of information about part categories and attributes of electrical components associated with the part categories;
determining shared attributes between the electrical components interrogated during the diagnostic scan and information in the database to identify likely part categories for one or more of the electrical components; and
storing identified likely part categories for one or more of the electrical components in one or more records of the database.

20. The process of claim 19, wherein the electrical components interrogated during the diagnostic scan comprise one or more electronic modules.

21. The process of claim 19, wherein the attributes comprise known diagnostic trouble codes, components, or vehicle features known to associated with one or more of the part categories.

22. The process of claim 19, wherein the attributes comprise known diagnostic trouble codes, components, or vehicle features known to not be associated with one or more of the part categories.

23. The process of claim 19, further comprising identifying one or more service part numbers/identifiers for hardware components interrogated during the diagnostic scan.
